(19) United States
(12) Patent Application Publication
(10) Pub. No.: US 2026/0100471 A1
(43) Pub. Date: Apr. 9, 2026

(54) COOLANT PLATE MODULATION FOR BATTERY MODULES OF AN ELECTRIFIED VEHICLE

(71) Applicant: FCA US LLC, Auburn Hills, MI (US)

(72) Inventors: Soumya Gudiyella, Auburn Hills, MI (US); Shui Yu, Auburn Hills, MI (US); Fadi Estefanous, Auburn Hills, MI (US); Tamer Badawy, Auburn Hills, MI (US)

(21) Appl. No.: 18/910,245

(22) Filed: Oct. 9, 2024

(51) Int. Cl. H01M 50/30; H01M 10/613; H01M 10/653; H01M 10/6554; H01M 10/6569

(52) U.S. Cl. CPC H01M 50/30; H01M 10/613; H01M 10/653; H01M 10/6554; H01M 10/6569

(57) ABSTRACT

A system includes a first battery module, a first cooling plate disposed adjacent to the first battery module, a second battery module spaced apart from the first battery module, a second cooling plate disposed adjacent to the second battery module and spaced apart from the first battery module and a first coolant path fluidically coupling the first cooling plate and the second cooling plate.

### FIELD

The present disclosure relates to battery modules for an electrified vehicle, and, more specifically, to a cooling system for cooling battery modules.

### BACKGROUND

This section provides background information related to the present disclosure which is not necessarily prior art.

High-energy lithium-ion battery packs pose a risk of thermal runaway. Thermal runaway is a phenomenon that occurs when the temperature of a system increases uncontrollably, leading to a self-heating process and a rapid rise in heat generation. Thermal runaway may be caused by different means, including but not limited to an internal or external short-circuit. In a short-circuit event, the separator in the cell is damaged, resulting in an increase in cell temperature. An example of an internal short-circuit is when the cell is damaged during the manufacturing process. An example of an external short-circuit is when the cell is damaged in a vehicle crash. Another important contributor to thermal runaway could be DCFC (Direct Current Fast Charging), where higher cell temperature can occur, leading to instability in chemistry of cell, resulting in thermal runaway. Thermal propagation occurs when heat spreads from one cell to adjacent cells, exacerbating the runaway reaction.

In a typical battery pack design, the modules are positioned on top of the cooling plate, with coolant circulating through channels to dissipate heat generated during normal operation. Enhanced heat conduction between the module bottom and the cooling plate is required, usually using a layer of thermally conductive resin. However, during thermal runaway, the cooling plate can become a conduit for thermal propagation between neighboring modules. Heat conduction through the cooling plate is identified as a primary pathway for thermal propagation.

### SUMMARY

This section provides a general summary of the disclosure, and is not a comprehensive disclosure of its full scope or all of its features.

The present system introduces a modular cooling plate design. By splitting the cooling plate into multiple sections, the design creates barriers to continuous heat transfer between modules, thus mitigating the risk of thermal propagation within the battery pack. Metrics used to evaluate thermal propagation include module-to-module thermal propagation time, internal battery pack pressure, and temperature of the pack cover.

In one aspect of the disclosure, a system includes a first battery module, a first cooling plate disposed adjacent to the first battery module, a second battery module spaced apart from the first battery module, a second cooling plate disposed adjacent to the second battery module and spaced apart from the first battery module and a first coolant path fluidically coupling the first cooling plate and the second cooling plate.

In another aspect of the disclosure, a method includes communicating coolant into a first cooling plate having a battery module associated therewith, communicating coolant into a first pipe toward a second cooling plate, communicating coolant into a second pipe from the first pipe, at least a portion of the first pipe and releasing coolant vapor in a coolant path including the second pipe through a valve.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a block diagrammatic view of a vehicle having a battery pack formed according to the present invention.

FIG. 1B is a side view of a battery pack having a battery module therein.

FIG. 1C is a plurality of battery modules having a common cooling plate thereunder according to the prior art.

FIG. 1D is a modular cooling plate design according to the present disclosure.

FIG. 1E is a side view of the modular cooling plate design of FIG. 1D.

FIG. 2 is a diagrammatic view of an alternative connection circuit with a valve therein.

FIG. 3 is a third example of a cooling coupling circuit having an expansion chamber and valve.

FIG. 4 is a plot of temperature versus time for a plurality of cells in three different modules including a trigger module triggered to form thermal runaway.

FIG. 5 is a plot of temperature versus time for illustrating cell temperatures for different cells within triggered and neighboring modules.

FIG. 6A is a plot of maximum pressure in a pack from a single cooling plate.

FIG. 6B is a maximum pressure in a battery pack having a modular coolant plate.

FIG. 7A is a maximum pack coverage temperature versus time plot for a single cooling plate such as the example in FIG. 1C.

FIG. 7B is a plot of maximum pack coverage temperature versus time for a module cooling plate design according to the present disclosure.

FIG. 8 is a high-level flowchart of a method for operating the system.

Corresponding reference numerals indicate corresponding parts throughout the several views of the drawings.

### DETAILED DESCRIPTION

Example embodiments will now be described more fully with reference to the accompanying drawings.

In the present disclosure, the modular cooling plate design may include various aspects including a pressure relief valve or bleeding device for each section (such as a rupture disc, relief valve, or cap that opens at a predetermined temperature or pressure). This feature allows localized pressure release, preventing potential damage to pack components. In a battery pack, the presence of coolant in the cooling channels can lower the temperature of the metal cooling plate due to the added thermal mass, thereby delaying thermal propagation to neighboring modules. During a thermal runaway event, the coolant temperature can exceed its boiling point, especially if the coolant is static and the circulation pump is not active. The phase change of coolant from liquid to gas absorbs significant heat, creating a supercooling boundary where evaporation occurs. While this phase change temporarily lowers the cooling plate temperature, the resulting gas generation can expel the coolant from the system, worsening cooling conditions for neighboring modules. Therefore, effectively releasing gas vapor (bubbles) in the cooling channels is essential to fully benefit from the coolant's phase change. Although circulating the coolant with a pump can release gas bubbles at the overflow expansion chamber outlet, bubbles can cause air locks that impede circulation. Additionally, the pump may not operate during a thermal runaway due to power draw constraints. Venting coolant through the vent valve disrupts heat transfer pathways, reducing the risk of thermal propagation. Therefore, the modular cooling plate with integrated vent valve is proposed to reduce the risk of thermal propagation.

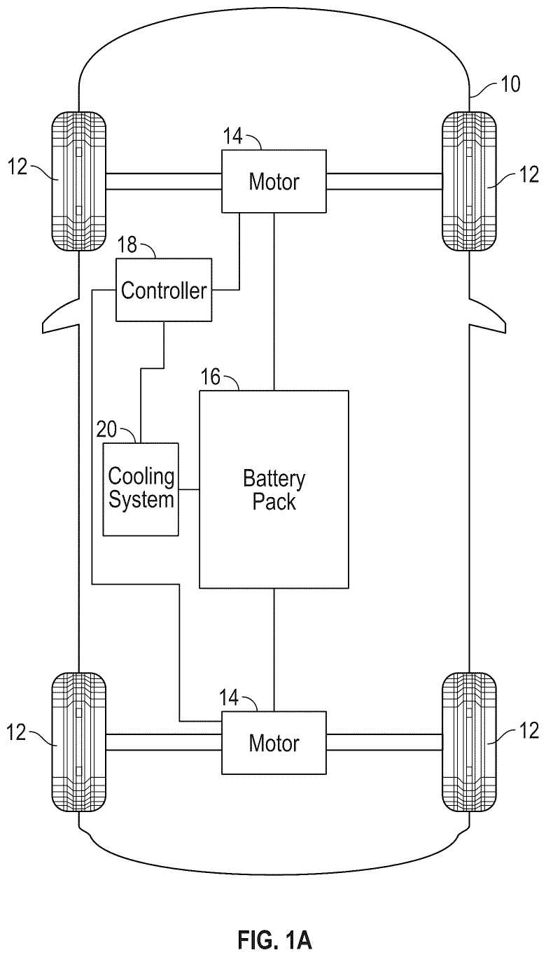

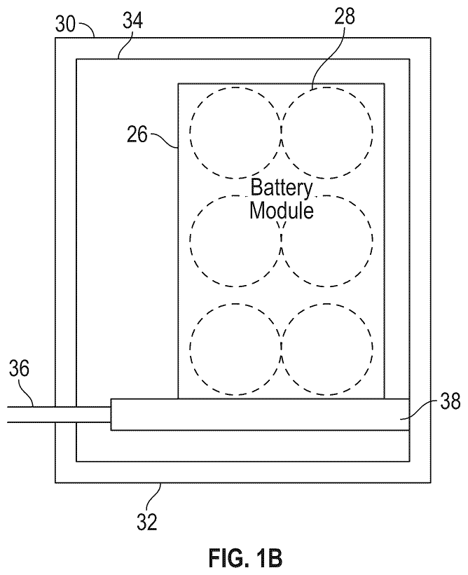

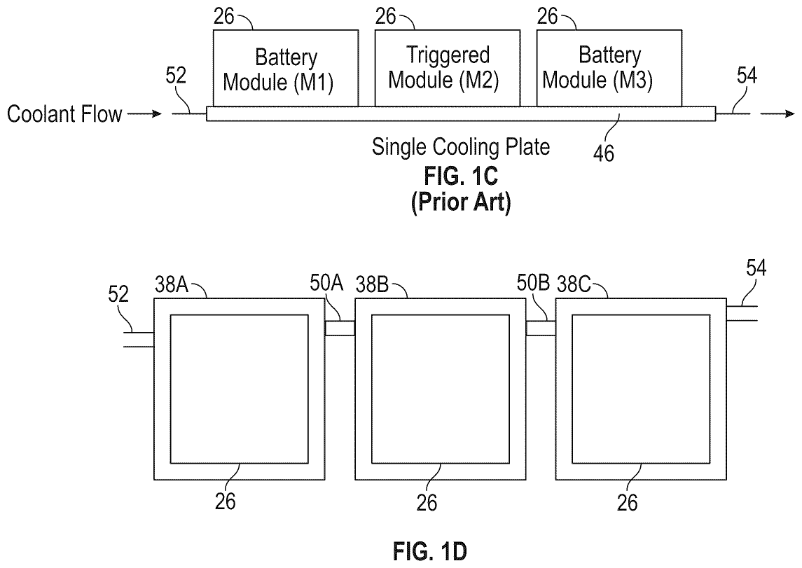

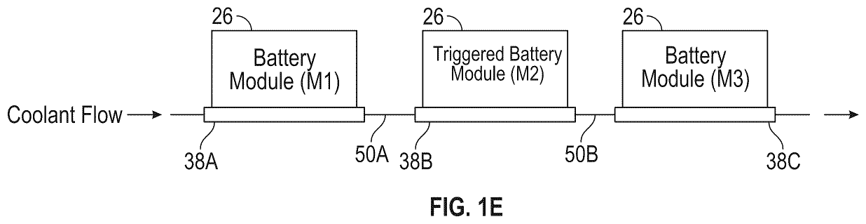

Referring now to FIG. 1A, the vehicle 10 is illustrated having a plurality of wheels/tire assemblies 12. The wheel and tire assemblies in this example are powered by motors 14 that coupled to a battery pack 16. Although two motors 14 are illustrated, one motor may be used for propelling the front or rear axle. Likewise, four motors 14 may be provided for propelling each of the four wheel and tire assemblies 12. The battery pack 16 and the motors 14 are controlled by a controller 18 that is microprocessor base. A cooling system 20 is coupled to the battery pack 16. The cooling system 20 is used for cooling the battery pack 16 and may be controlled by the controller 18.

Referring now to FIG. 1B, the battery pack 16 is comprised of a plurality of battery modules 26. Each of the battery modules 26 comprises a number of battery cells 28. In this example, six battery cells 28 are illustrated. However, different numbers of battery cells may be provided in each battery module 26. The module 26 is provided within a battery pack housing 30 that comprises a bottom tray 32 and a battery pack cover 34. A coolant channel 36 provides coolant to a cooling plate 38.

In FIG. 1C, a plurality of battery modules 26 are illustrated according to the prior art. In this example, three battery modules 26 are illustrated coupled to a single cooling plate 46 that extends beneath each of the modules 26. The cooling plate 46 is continuous and has potential thermal runaway issues as will be described in greater detail below.

Referring now to FIGS. 1D and 1E, a plurality of modulated cooling plates 38 are illustrated. The cooling plates 38 are collectively referred to with the single reference number. However, the cooling plates are represented by reference numerals 38A, 38B and 38C. The cooling plates 38A, 38B and 38C are sized to be about the same size as the battery modules 26. A first coolant path 50A couples the first cooling plate 38A and the second cooling plate 38B. A second cooling plate 50B couples the second cooling plate 38B and the third cooling plate 38C. Although three cooling plates 38 are illustrated, more than three cooling plates may be combined in a single battery pack. Both examples in FIG. 1C in the prior art and FIG. 1D have a coolant inlet 52 and a coolant outlet 54. The coolant inlet 52 and the coolant outlet 54 may be fluidically coupled to various cooling components such as a heat exchanger (not illustrated).

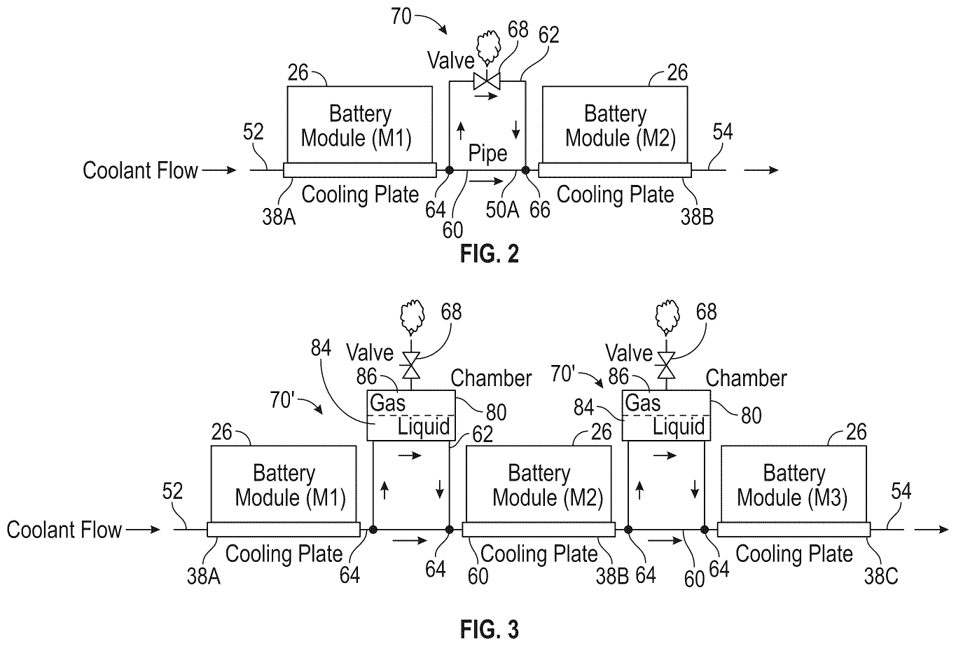

Referring now to FIG. 2, the same reference numerals are used for the same components as in FIG. 1D. In FIG. 2, the fluid path 50A includes a first pipe 60 and a second pipe 62. The second pipe 62 is coupled to the first pipe 60 at a first intersection 64 and a second intersection 66 that is downstream of the first intersection 64 to reconnect the second pipe to the first pipe. The second pipe 62 extends in a vertical direction and therefore a valve 68 is disposed in the second pipe 62 is higher vertically or in elevation than the first pipe 60. The valve 68 is a coolant vent valve configured to release coolant vapor. The second pipe 62 is used as gas-liquid separator. The vapor gas bubbles within the first pipe 60 find their way into the second pipe 62 and the highest point of the second pipe 62 has the coolant vent valve 68. During normal battery operation, liquid coolant fills coolant circuit 70 by flowing through the first pipe 60 and the second pipe 62. Gas bubbles of vapor form in the coolant circuit 70 and accumulate at the highest point which is where the valve 68 is located. The valve 68 is used to discharge the coolant vapor to help prevent thermal runaway. Each battery module 26 may have the coolant circuit 70 therebetween.

Referring now to FIG. 3, an alternative coolant circuit 70′ is set forth. In this example, the second pipe 62 has a bypass expansion chamber 80 disposed therein. The bypass expansion chamber 80 is used to separate liquid 84 from gas 86. The gas 86 rises within the expansion chamber 80 and is released through the valve 68 as described above relative to FIG. 2. The large expansion chamber 80 allows more capacity for gas accumulation and release compared to that illustrated in FIG. 2. This enhances the efficiency of the venting process. By incorporating the valve 68 at each coolant plate 38A, 38B, a localized mechanism to release pressure is created. The valve allows controlled release of evaporated coolant to prevent potential damage to the battery pack 16. Venting out the coolant through the valve 68 disrupts the heat transfer channels and limits the chances of heat transfer between the individual battery cells and battery modules 26. The risk of thermal propagation is reduced.

The composition of the components of the first pipe 60 and the second pipe 62 may be the same in that they may be formed of a material that has a thermal conductivity less than the thermal conductivity of the cooling plates 38A, 38B.

As mentioned above, the battery modules may each have the coolant circuit 70′ therebetween. The coolant circuits may be those in FIG. 2 or FIG. 3. In this example, the second coolant circuit 70′ is labelled with the same reference numbers. A coolant circuit 70 or 70′ may be located between each battery module 26. The circuits 70 and 70′ may be interchangeable wherein both types are used in a battery pack.

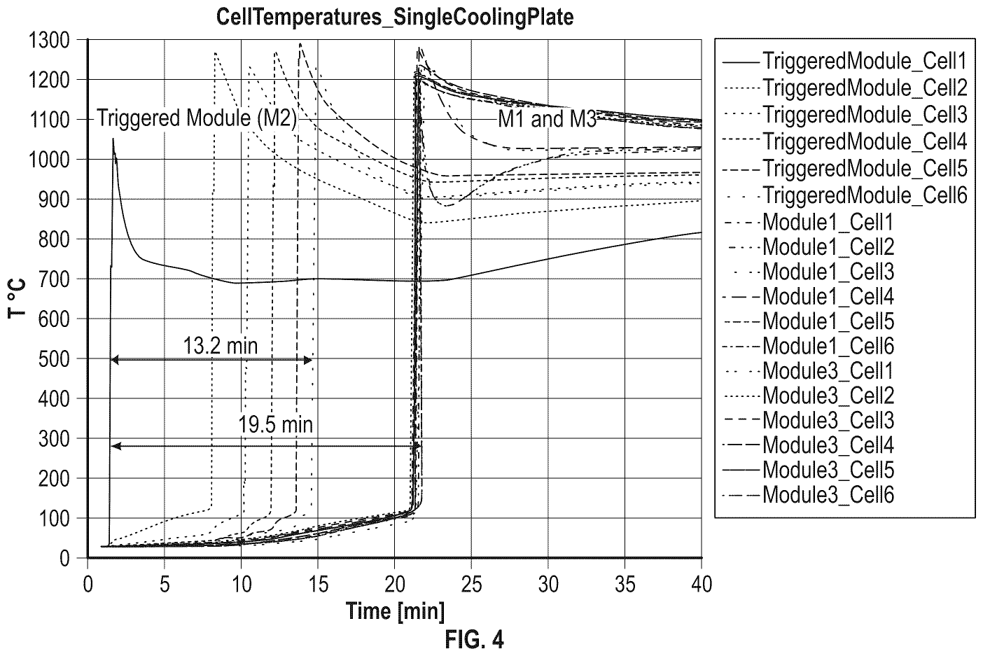

Referring now to FIG. 4, in the case of a single cooling plate of the prior art as in FIG. 1C and modular cooling plates as in FIGS. 1D and 1E of the present design, the center module is triggered for thermal runaway. In other words, the first cell in the module was heated using the heater, until thermal runaway occurred in the center battery module. The metrics used to evaluate thermal runaway mitigation are module-to-module thermal propagation, pressure in the last battery pack (on the right in the Figures) and battery pack cover temperature.

Each module in this example has 6 cells. FIG. 4 shows the cell temperatures of the triggered module and neighboring modules, with a single cooling plate design. The first cell in the trigger module is heated using a heating pad, which results in thermal runaway of the cell. The thermal runaway is propagated in the triggered module (M2) from Cell 1 to Cell 6, as seen from the high temperature of the remaining cells. Module-to-module thermal propagation also occurs, as observed from the high cell temperatures of the cells in the neighboring modules, namely Module1 (M1) and Module3 (M3), as illustrated in FIG. 1E. With a single cooling plate, the module-to-module thermal propagation takes approximately 20 minutes.

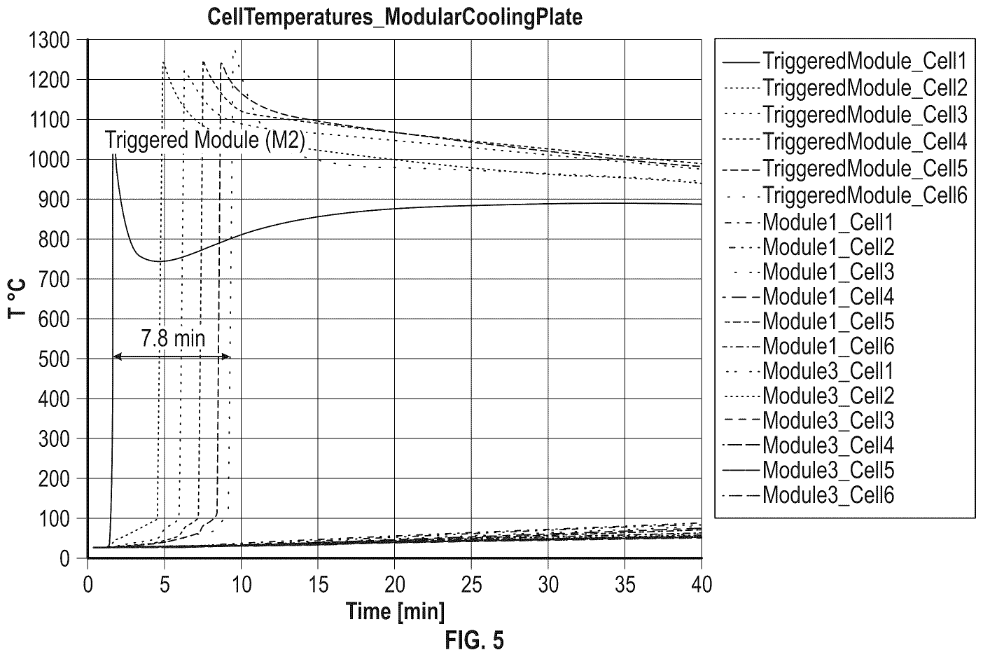

Referring now to FIG. 5, the cell temperatures of the triggered module and neighboring modules, with a modular cooling plate design is shown. Similar to the single cooling plate study, the first cell in the trigger module is heated using a heating pad, which results in thermal runaway of the cell. The thermal runaway is propagated in the triggered module (M2) from Cell 1 to Cell 6, as seen from the high temperature of the remaining cells. However, it was observed that module-to-module thermal propagation has not occurred, as evident from the low cell temperatures of the cells in the neighboring modules, M1 and M3. In other words, thermal runaway did not happen in M1 and M3. Therefore, it is proved that a modular cooling plate design helps in preventing thermal propagation to other modules.

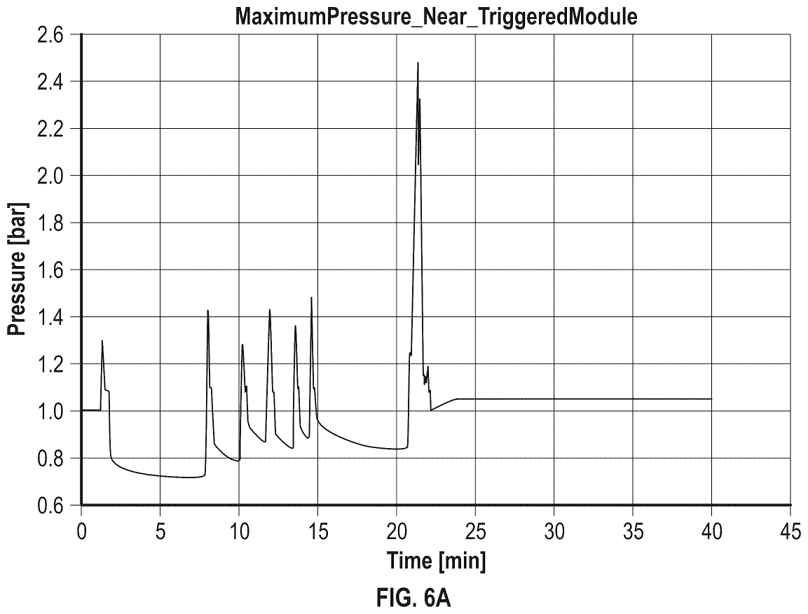

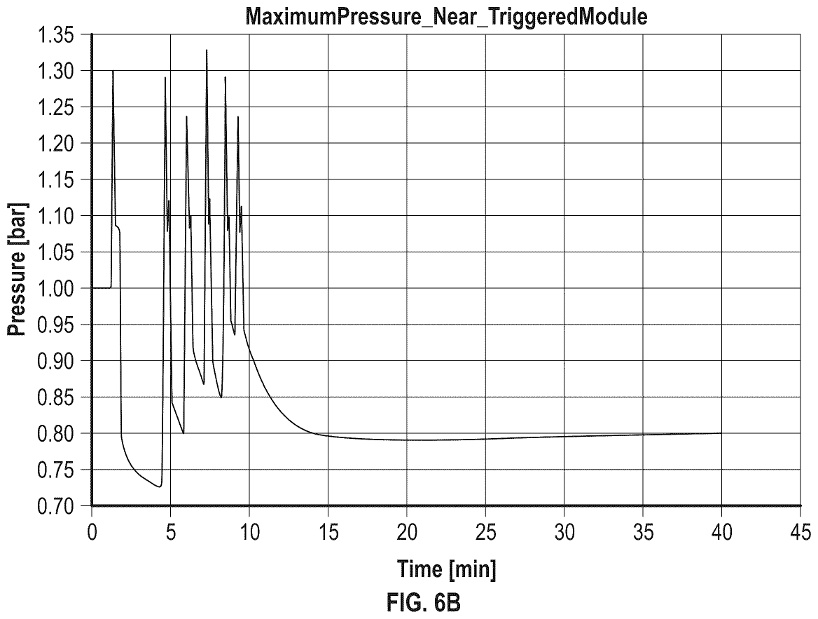

Referring now to FIGS. 6A and 6B, in addition to module-to-module thermal propagation time, the other metrics for thermal runaway mitigation are the maximum peak pressure within the pack and the pack peak cover temperature. FIG. 6A shows the maximum pressure sensed in pack with single cooling plate. FIG. 6B shows the maximum pressure sensed in pack with modular cooling plates. While the absolute pressure numbers could vary based on the pack design, in general, the peak pressure in pack is lower with a modular cooling plate.

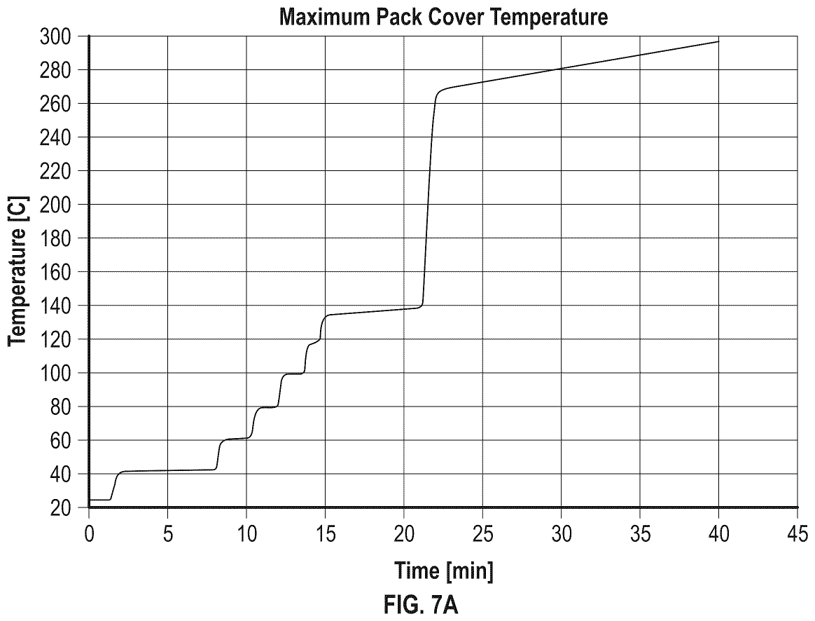

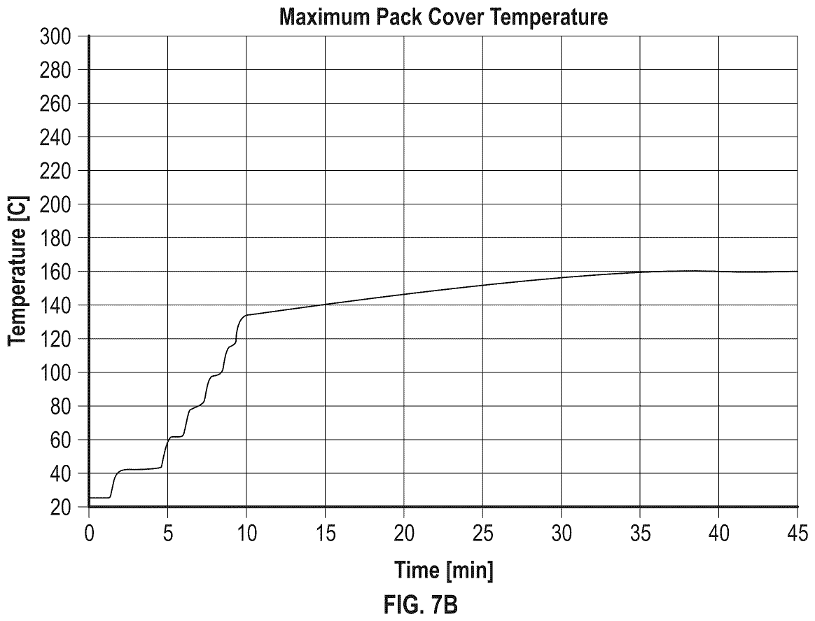

Referring now to FIGS. 7A and 7B, the plot below shows the maximum pack cover temperature predicted by single cooling plate model in FIG. 7A and a modular cooling plate model in FIG. 7B. While the absolute pressure numbers could vary based on the pack design, in general, the maximum pack cover temperature is lower with a modular cooling plate.

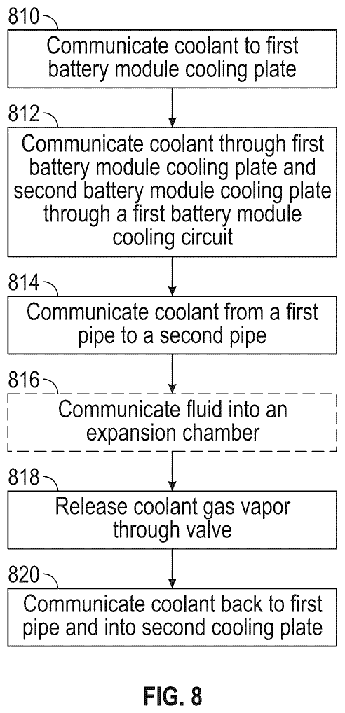

Referring now to FIG. 8, the operation of the system is set forth. In step 810, coolant is communicated to the first battery module cooling plate in step 810. In step 812, coolant is communicated through a first pipe between the first battery module cooling plate and a second battery module cooling plate through a first coolant circuit having a first pipe. In step 814, the coolant is communicated from the first pipe through a second pipe of the coolant circuit. In step 816, the coolant is communicated from the second pipe into an expansion chamber. Step 816 is an optional step since an expansion chamber may not be present. After step 816, step 818 releases coolant vapor (bubbles in the liquid coolant that collect near the valve) through a valve either at the expansion chamber or at the second pipe. Thereafter, the coolant fluid within the second pipe is communicated to a second intersection at the first pipe and ultimately into the second cooling plate in the series in step 820. The process may be repeated for multiple cooling plates as illustrated in FIGS. 2 and 3.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system comprising:
a first battery module;
a first cooling plate disposed adjacent to the first battery module;
a second battery module spaced apart from the first battery module;
a second cooling plate disposed adjacent to the second battery module and spaced apart from the first battery module; and
a first coolant path fluidically coupling the first cooling plate and the second cooling plate.

2. The system of claim 1 wherein the first battery module is composed of a first material with a first thermal conductivity and the first coolant path is composed of a second material with a second thermal conductivity less than the first thermal conductivity.

3. The system of claim 1 wherein the first coolant path comprises a first pipe.

4. The system of claim 1 wherein the first coolant path comprises a first pipe and a second pipe.

5. The system of claim 4 wherein the second pipe is coupled to the first pipe at a first intersection and a second intersection.

6. The system of claim 4 wherein the second pipe comprises a coolant vent valve therein.

7. The system of claim 6 wherein the coolant vent valve is configured to release coolant vapor from the second pipe.

8. The system of claim 4 wherein the second pipe comprises a bypass expansion chamber.

9. The system of claim 8 wherein the bypass expansion chamber comprises a coolant vent valve therein.

10. The system of claim 9 wherein the coolant vent valve is configured to release coolant vapor from the second pipe.

11. The system of claim 1 further comprising:
a third battery module spaced apart from the second battery module;
a third cooling plate disposed adjacent to the third battery module; and
a second coolant path fluidically coupling the second cooling plate and the third cooling plate.

12. The system of claim 11 wherein the second coolant path comprises a third pipe and a fourth pipe.

13. The system of claim 12 wherein the fourth pipe is coupled to the third pipe at a third intersection and a fourth intersection.

14. The system of claim 12 wherein the fourth pipe comprises a second coolant vent valve therein.

15. The system of claim 14 wherein the second coolant vent valve is configured to release coolant vapor from the fourth pipe.

16. The system of claim 12 wherein the fourth pipe comprises a second bypass expansion chamber.

17. The system of claim 16 wherein the second bypass expansion chamber comprises a second coolant vent valve therein.

18. A method comprising:
communicating coolant into a first cooling plate having a battery module associated therewith;
communicating coolant into a first pipe toward a second cooling plate;
communicating coolant into a second pipe from the first pipe, at least a portion of the first pipe; and
releasing coolant vapor in a coolant path including the second pipe through a valve.

19. The method of claim 18 further comprising communicating coolant to an expansion chamber in the second pipe.

20. The method of claim 19 wherein releasing coolant vapor comprises releasing the coolant vapor from the valve coupled to an expansion chamber.
